(19) United States
(12) Patent Application Publication
(10) Pub. No.: US 2024/0232498 A1
(43) Pub. Date: Jul. 11, 2024

(54) APPARATUS AND METHOD WITH CIRCUIT DESIGNING

(71) Applicant: SAMSUNG ELECTRONICS CO., LTD., Suwon-si (KR)

(72) Inventors: Hyung-Dal KWON, Suwon-si (KR); Youngmin OH, Suwon-si (KR); Bosun HWANG, Suwon-si (KR)

(73) Assignee: SAMSUNG ELECTRONICS CO., LTD., Suwon-si (KR)

(21) Appl. No.: 18/350,419

(22) Filed: Jul. 11, 2023

(30) Foreign Application Priority Data
Jan. 5, 2023 (KR) 10-2023-0001641

(51) Int. Cl. G06F 30/392; G06F 30/398

(52) U.S. Cl. CPC G06F 30/392; G06F 30/398; G06F 2111/06

(57) ABSTRACT

An apparatus with circuit designing may include: one or more processors configured to: generate an initial solution set based on nodes and edges comprised in a graph corresponding to a circuit to be optimized; generate a crossover solution by performing a crossover operation based on a plurality of solutions comprised in the initial solution set; perform a first change of positions of nodes comprised in the crossover solution by performing a mutation operation on the crossover solution; and generate a target circuit structure by performing a second change of the positions of the first changed nodes based on lengths of the edges connecting the nodes.

### CROSS-REFERENCE TO RELATED APPLICATIONS

This application claims the benefit under 35 USC § 119(a) of Korean Patent Application No. 10-2023-0001641, filed on Jan. 5, 2023 in the Korean Intellectual Property Office, the entire disclosure of which is incorporated herein by reference for all purposes.

### BACKGROUND

### 1. Field

The following description relates to an apparatus and method with circuit designing.

### 2. Description of Related Art

A genetic algorithm may be a computational model based on the evolutionary process of the natural world and is a technique for solving optimization issues. A genetic algorithm may be based on the biological genetics of the natural world and may be a parallel and global search algorithm based on Darwin's theory of survival of the fittest.

A genetic algorithm may express possible solutions to an issue to be solved in a data structure of a fixed form, and then gradually transform them to produce better solutions.

A genetic algorithm may be used to optimize a circuit structure. However, it may be difficult to achieve high optimization performance when a genetic algorithm is used, and thus, a heuristic algorithm may have to be added to overcome the limitations of a genetic algorithm.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, an apparatus with circuit designing includes: one or more processors configured to: generate an initial solution set based on nodes and edges comprised in a graph corresponding to a circuit to be optimized; generate a crossover solution by performing a crossover operation based on a plurality of solutions comprised in the initial solution set; perform a first change of positions of nodes comprised in the crossover solution by performing a mutation operation on the crossover solution; and generate a target circuit structure by performing a second change of the positions of the first changed nodes based on lengths of the edges connecting the nodes.

The nodes comprised in the graph may correspond to elements comprising the circuit, and the edges comprised in the graph correspond to wires connecting the elements.

For the generating of the crossover solution, the one or more processors may be configured to: select a portion of solutions from among the plurality of solutions comprised in the initial solution set; and generate the crossover solution by performing a crossover operation on the portion of solutions.

For the performing of the first change, the one or more processors may be configured to: randomly set node values for the nodes comprised in the crossover solution; and perform the first change of the positions of the nodes by comparing the node values to a threshold.

For the performing of the first change of the positions of the nodes by comparing the node values to the threshold, the one or more processors may be configured to perform the first change of the positions of nodes of which the node value is less than or equal to the threshold.

For the generating of the target circuit structure, the one or more processors may be configured to: generate an intermediate solution set by performing local optimization by performing the second change of the positions of the first changed nodes; and generate the target circuit structure by replacing the portion of solutions of the initial solution set with the intermediate solution set.

For the generating of the intermediate solution set, the one or more processors may be configured to: determine a first wire length of a wire corresponding to edges connected to each of the first changed nodes; select a change node of which a position is to be changed from among the first changed nodes based on the determined first wire length; determine a second wire length of a wire according to the position change of the change node; and generate the intermediate solution set by performing the second change of the positions of the first changed nodes based on the determined first wire length and the determined second wire length.

For the determining of the first wire length, the one or more processors may be configured to determine the first wire length by adding a length of the wire connected to one side of the first changed nodes and a length of the wire connected to the other side of the first changed nodes.

For the selecting of the change node, the one or more processors may be configured to select the change node based on a length difference between the two wires connected to the first changed nodes.

For the generating of the target circuit structure by replacing the intermediate solution set, the one or more processors may be configured to: determine whether the solutions of the replaced intermediate solution set satisfy termination criteria; and determine a solution that satisfies the termination criteria as the target circuit structure.

In one or more general aspects, a processor-implemented method with circuit designing includes: generating an initial solution set based on nodes and edges comprised in a graph corresponding to a circuit to be optimized; generating a crossover solution by performing a crossover operation based on a plurality of solutions comprised in the initial solution set; performing a first change of positions of nodes comprised in the crossover solution by performing a mutation operation on the crossover solution; and generating a target circuit structure by performing a second change of the positions of the first changed nodes based on lengths of the edges connecting the nodes.

The nodes comprised in the graph may correspond to elements comprising the circuit, and the edges comprised in the graph correspond to wires connecting the elements.

The generating of the crossover solution may include: selecting a portion of solutions from among the plurality of solutions comprised in the initial solution set; and generating the crossover solution by performing a crossover operation on the portion of solutions.

The performing of the first change may include: randomly setting node values for the nodes comprised in the crossover solution; and performing the first change of the positions of the nodes by comparing the node values to a threshold.

The performing of the first change of the positions of the nodes by comparing the node values to the threshold may include performing the first change of the positions of nodes of which the node value is less than or equal to the threshold.

The generating of the target circuit structure may include: generating an intermediate solution set by performing local optimization by performing the second change of the positions of the first changed nodes; and generating the target circuit structure by replacing the portion of solutions of the initial solution set with the intermediate solution set.

The generating of the intermediate solution set may include: determining a first wire length of a wire corresponding to edges connected to each of the first changed nodes; selecting a change node of which a position is to be changed from among the first changed nodes based on the determined first wire length; determining a second wire length of a wire according to the position change of the change node; and generating the intermediate solution set by performing the second change of the positions of the first changed nodes based on the determined first wire length and the determined second wire length.

The determining of the first wire length may include determining the first wire length by adding a length of the wire connected to one side of the first changed nodes and a length of the wire connected to the other side of the first changed nodes.

The selecting of the change node may include selecting the change node based on a length difference between the two wires connected to the first changed nodes.

The generating of the target circuit structure by replacing the intermediate solution set may include: determining whether the solutions of the replaced intermediate solution set satisfy termination criteria; and determining a solution that satisfies the termination criteria as the target circuit structure.

Other features and aspects will be apparent from the following detailed description, the drawings, and the claims.

### BRIEF DESCRIPTION OF THE DRAWINGS

FIG. 1 illustrates an example apparatus with circuit designing, according to one or more embodiments.

FIG. 2 illustrates an example circuit structure before optimization is performed, according to one or more embodiments.

FIG. 3 illustrates an example result of optimizing a circuit structure, according to one or more embodiments.

FIG. 4 illustrates an example process by which an apparatus optimizes a circuit structure, according to one or more embodiments.

FIG. 5 illustrates an example operation of optimizing a circuit structure performed by an apparatus, according to one or more embodiments.

FIG. 6 illustrates an example select operation, according to one or more embodiments.

FIG. 7 illustrates an example crossover operation, according to one or more embodiments.

FIG. 8 illustrates an example mutation operation, according to one or more embodiments.

FIG. 9 illustrates an example operation of a local optimization, according to one or more embodiments.

FIG. 10 illustrates an example of a local optimization process, according to one or more embodiments.

FIG. 11 illustrates an example process of changing a position of a node, according to one or more embodiments.

FIG. 12 illustrates an example process for minimizing a length of a wire, according to one or more embodiments.

FIG. 13 illustrates an example process of changing a position of a node along a total wire length, according to one or more embodiments.

FIG. 14 illustrates an example of a change in wire length according to a movement of a position of a node, according to one or more embodiments.

FIG. 15 illustrates an example operation of an apparatus, according to one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Unless otherwise defined, all terms including technical and scientific terms used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

When describing the examples with reference to the accompanying drawings, like reference numerals refer to like constituent elements and a repeated description related thereto will be omitted. In the description of the examples, a detailed description of well-known related structures or functions will be omitted when it is deemed that such description will cause ambiguous interpretation of the present disclosure.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as being “connected to,” “coupled to,” or “joined to” another component or element, it may be directly (e.g., in contact with the other component or element) “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning. The use of the term “may” herein with respect to an example or embodiment, e.g., as to what an example or embodiment may include or implement, means that at least one example or embodiment exists where such a feature is included or implemented, while all examples are not limited thereto.

The same name may be used to describe an element included in the examples described above and an element having a common function. Unless otherwise mentioned, the descriptions of the examples may be applicable to the following examples and thus, duplicated descriptions will be omitted for conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

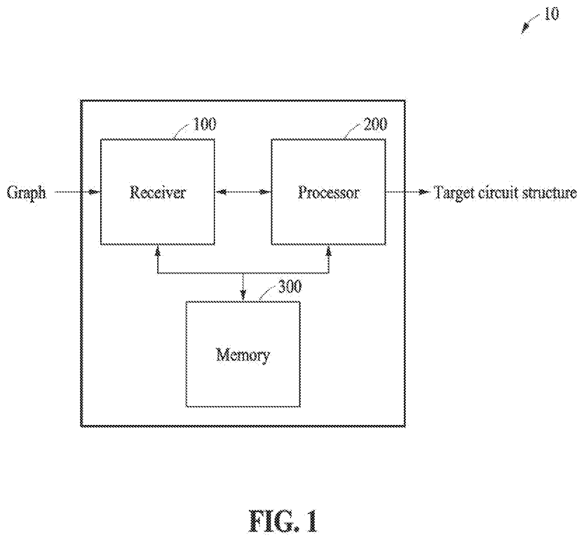

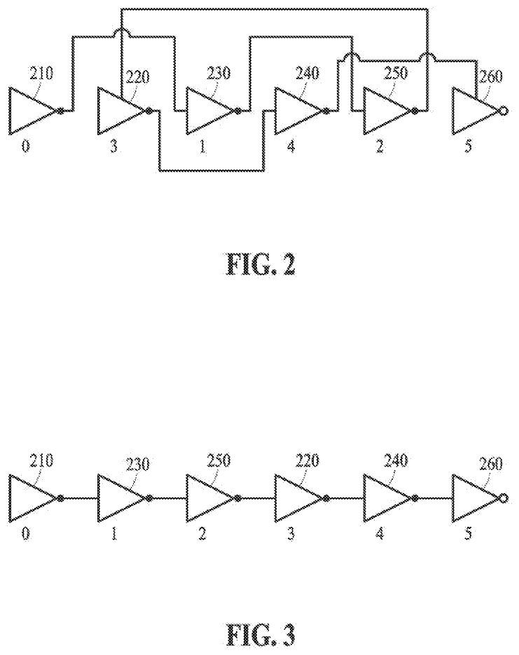

FIG. 1 illustrates an example apparatus with circuit designing, according to one or more embodiments, FIG. 2 illustrates an example circuit structure before optimization is performed, according to one or more embodiments, and FIG. 3 illustrates an example result of optimizing a circuit structure (e.g., the circuit structure of FIG. 2), according to one or more embodiments.

Referring to FIGS. 1 to 3, an apparatus 10 with circuit designing (e.g., for designing a circuit) may design a circuit (e.g., may determine a circuit design). The apparatus 10 for designing a circuit may generate a target circuit structure by receiving a graph corresponding to the circuit structure. The graph may be a data structure made up of points and lines. A point may be referred to as a node, and a line may be referred to as an edge. The node may correspond to an element that makes up a circuit. The edge may correspond to a wire electrically connecting an element to another element.

The apparatus 10 for designing a circuit may generate a circuit structure that minimizes a length of an edge when a graph represented by nodes and edges connected to the nodes is laid out in one dimension.

The apparatus 10 for designing a circuit may optimize the circuit structure of the example of FIG. 2 as illustrated in FIG. 3. The example of FIG. 2 may be a circuit in which a plurality of inverters 210, 220, 230, 240, 250, and 260 are arranged regardless of the lengths of the wires. The apparatus 10 for designing a circuit may generate an optimized target circuit structure as illustrated in FIG. 3 by processing a graph corresponding to the circuit structure of FIG. 2. The apparatus 10 for designing a circuit may optimize the circuit structure of FIG. 2 and change the inverters included in the circuit to the order of 210, 230, 250, 220, 240, and 260 as illustrated in FIG. 3.

The apparatus 10 for designing a circuit may be, or be included in, a personal computer (PC), a data server, and/or a portable device.

The portable device may be or include, for example, a laptop computer, a mobile phone, a smartphone, a tablet PC, a mobile Internet device (MID), a personal digital assistant (PDA), an enterprise digital assistant (EDA), a digital still camera, a digital video camera, a portable multimedia player (PMP), a personal or portable navigation device (PND), a handheld game console, an e-book, and/or a smart device. The smart device may be implemented as, for example, a smartwatch, a smart band, and/or a smart ring.

The apparatus 10 for designing a circuit may include a receiver 100 and a processor 200 (e.g., one or more processors). The apparatus 10 for designing a circuit may further include a memory 300 (e.g., one or more memories).

The receiver 100 may include a receiving interface. The receiver 100 may receive data including graphs. The receiver 100 may receive data from the outside or from the memory 300. The receiver 100 may output the received data to the processor 200.

The receiver 100 may receive a graph corresponding to a circuit to be optimized. The receiver 100 may output the received graph to the processor 200.

The processor 200 may process data stored in the memory 300. The processor 200 may execute computer-readable code (e.g., software) stored in the memory 300 and instructions triggered by the processor 200.

The processor 200 may be a hardware data processing device including a circuit having a physical structure to perform desired operations. For example, the desired operations may include code or instructions included in a program.

For example, the hardware data processing device may include a microprocessor, a central processing unit (CPU), a processor core, a multi-core processor, a multiprocessor, an application-specific integrated circuit (ASIC), and/or a field-programmable gate array (FPGA).

The processor 200 may generate an initial solution set based on the nodes and edges included in the graph. The processor 200 may generate a crossover solution by performing a crossover operation based on a plurality of solutions included in the initial solution set.

To generate the crossover solution, the processor 200 may select a portion of solutions from among a plurality of solutions included in the initial solution set, and the processor 200 may generate the crossover solution by performing a crossover operation on the portion of solutions.

The processor 200 may make a first change of the positions of nodes included in the crossover solution by performing a mutation operation on the crossover solution. The processor 200 may randomly set node values for the nodes included in the crossover solution.

The processor 200 may make the first change of the positions of the nodes by comparing the node values to a threshold. The processor 200 may make the first change of the positions of nodes having a node value less than or equal to the threshold.

The processor 200 may generate a target circuit structure by making a second change of the positions of the first changed nodes based on the lengths of edges connecting the nodes. The processor 200 may generate an intermediate solution set by performing local optimization by making the second change of the positions of the first changed nodes.

The processor 200 may perform a first calculation (e.g., determination) of a length of a wire corresponding to edges connected to each of the first changed nodes. The processor 200 may perform the first calculation of the length of the wire by adding a length of the wire connected to one side of the first changed nodes and a length of the wire connected to the other side of the first changed nodes.

The processor 200 may select a change node of which a position is to be changed from among the first changed nodes based on the first calculated wire length. The processor 200 may select a change node based on a length difference between the two wires connected to the first changed nodes.

The processor 200 may perform a second calculation of a length of the wire according to the position change of the change node.

The processor 200 may generate an intermediate solution set by making the second change of the positions of the first changed nodes based on the first calculated wire length and the second calculated wire length.

The processor 200 may generate a target circuit structure by replacing a portion of solutions of the initial solution set with the intermediate solution set. The processor 200 may determine whether the solutions of the replaced intermediate solution set satisfy termination criteria. The processor 200 may determine a solution that satisfies the termination criteria as the target circuit structure.

The memory 300 may store instructions (or programs) executable by the processor 200. For example, the instructions may include instructions for performing an operation of the processor 200 and/or an operation of each component of the processor 200. For example, the memory 300 may be or include a non-transitory computer-readable storage medium storing instructions that, when executed by the processor 200, configure the processor 200 to perform any one, any combination, or all of the operations and methods described herein with reference to FIGS. 1-15.

The memory 300 may be implemented as a volatile memory device or non-volatile memory device.

The volatile memory device may be implemented as a dynamic random-access memory (DRAM), a static random-access memory (SRAM), a thyristor RAM (T-RAM), a zero capacitor RAM (Z-RAM), and/or a twin transistor RAM (TTRAM).

The non-volatile memory device may be implemented as an electrically erasable programmable read-only memory (EEPROM), a flash memory, a magnetic RAM (MRAM), a spin-transfer torque-MRAM (STT-MRAM), a conductive bridging RAM (CBRAM), a ferroelectric RAM (FeRAM), a phase change RAM (PRAM), a resistive RAM (RRAM), a nanotube RRAM (NRAM), a polymer RAM (PoRAM), a nano-floating gate memory (NFGM), a holographic memory, a molecular electronic memory device, and/or an insulator resistance change memory.

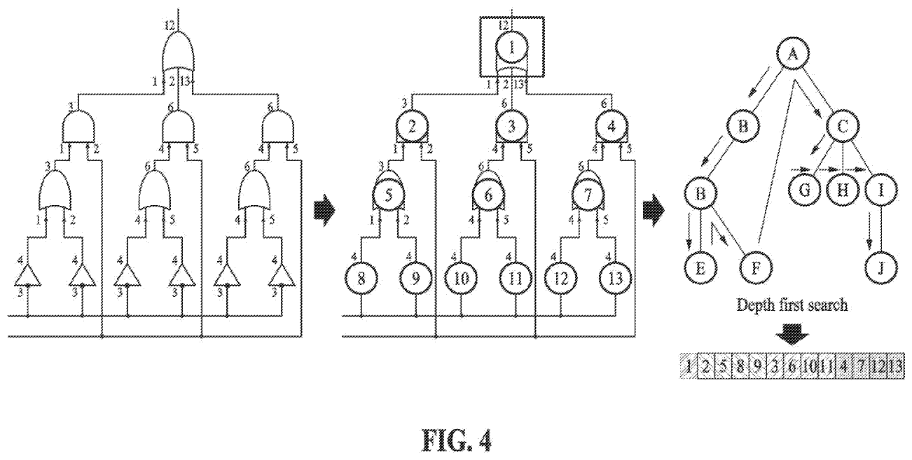

FIG. 4 illustrates an example process by which an apparatus (e.g., the apparatus of FIG. 1) optimizes a circuit structure, according to one or more embodiments.

Referring to FIG. 4, a processor (e.g., the processor 200 of FIG. 1) may optimize a position where a node is placed such that a length of an edge is minimized.

In a non-optimal arrangement, the length of the edge (or wire) may not be minimized. The processor 200 of one or more embodiments may minimize the length of the edge by placing the nodes by optimizing an order of the nodes.

The processor 200 may generate a circuit structure having an optimal one-dimensional arrangement from a graph made up of nodes and edges.

The processor 200 may generate an optimal placement candidate to use in a genetic algorithm. The processor 200 may generate an optimal placement candidate using depth-first search (DFS) and/or breadth-first search (BFS). The processor 200 may minimize a total sum of the lengths of wires connected to the nodes using the optimal placement candidate.

The processor 200 may use a result of placing each node of the graph in DFS order as the optimal placement candidate. Alternatively or additionally, the processor 200 may use a result of placing each node of the graph in BFS order as the optimal placement candidate.

The processor 200 may generate a result of placing N DFS and/or N BFS as the optimal placement candidate (e.g., an optimal solution candidate) for a graph having N nodes (where N is a natural number).

The processor 200 may generate an optimal solution candidate by adding randomly generated solution candidates to solutions generated by the DFS and BFS. The processor 200 may reduce the search time for an optimal solution by adjusting a ratio of the solutions generated by the DFS, the solutions generated by the BFS, or the solution candidates that are added.

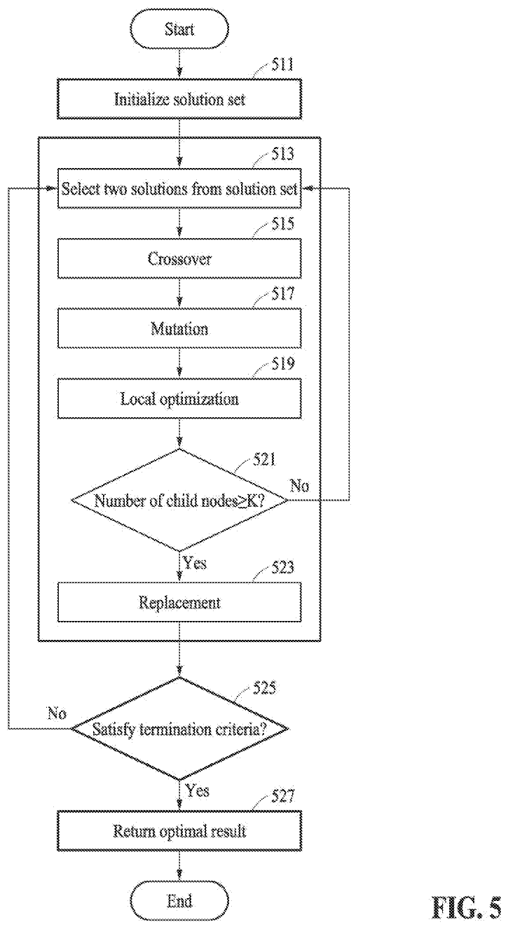

FIG. 5 illustrates an example operation of optimizing a circuit structure performed by an apparatus (e.g., the apparatus of FIG. 1), according to one or more embodiments.

Referring to FIG. 5, in operation 511, a processor (e.g., the processor 200 of FIG. 1) may initialize a solution set.

In operation 511, the processor 200 may randomly generate a solution set (or population) having a plurality of node placements without knowing the optimal placement of the nodes. The processor 200 may generate placements that are in a DFS order in which each node of a graph is a root as many as the number of the nodes and include the placements in the solution set. The processor 200 may generate placements that are in a BFS order as many as the number of the nodes and include the placements in the solution set.

The processor 200 may search for the optimal placement of the nodes faster than randomly generating a solution set using a solution (e.g., an optimal placement candidate) generated by DFS or BFS.

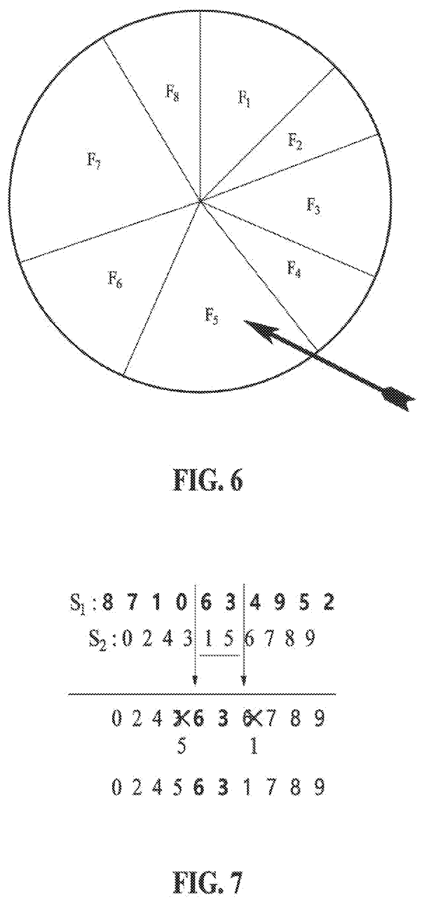

In operation 513, the processor 200 may select a portion of solutions from among a plurality of solutions included in an initial solution set. For example, in operation 513, the processor 200 may select two solutions from the initial solution set. A non-limiting example of the process of selecting a solution will be described in detail with reference to FIG. 6.

In operation 515, the processor 200 may perform a crossover operation based on the selected solution. The processor 200 may generate a crossover solution by performing a crossover operation on the portion of solutions.

In operation 517, the processor 200 may perform a mutation operation on the crossover solution. The processor 200 may make a first change of the positions of nodes included in the crossover solution by performing the mutation operation on the crossover solution.

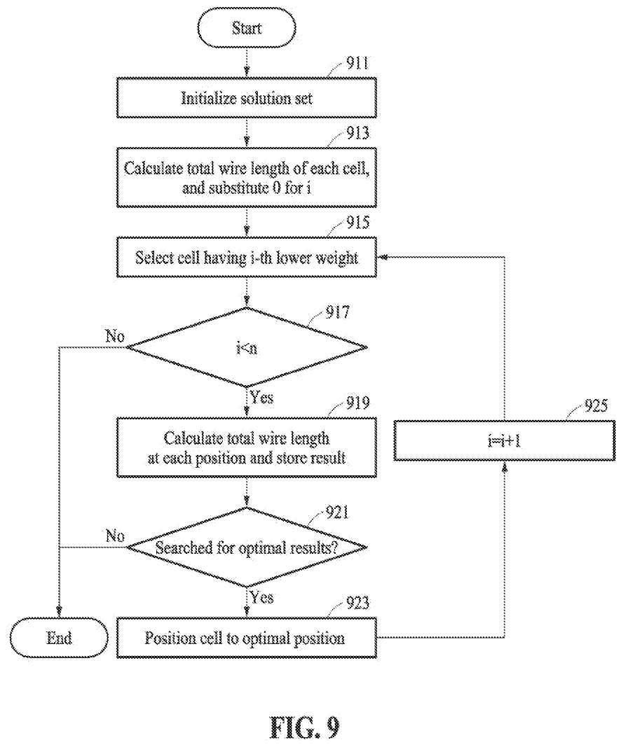

In operation 519, the processor 200 may perform local optimization on a result of the mutation operation. A non-limiting example of the process of local optimization will be described in detail with reference to FIG. 9.

In operation 521, the processor 200 may determine whether the number of child nodes is greater than or equal to K. When the condition of operation 521 is satisfied, the processor 200 may perform replacement of the solution set in operation 523.

In operation 523, the processor 200 may exchange K solutions newly generated through local optimization with solutions of the existing solution set. The processor 200 may replace a solution of a solution set using genitor-style replacement. The processor 200 may sequentially replace solutions having low fitness values in the solution set. Fitness may be the quality of a solution. The quality of a solution may include a total sum of a wire length. The processor 200 may not perform replacement when the quality of a generated child solution is poor. The processor 200 may increase diversity by selectively exchanging a portion of the child solutions with parent solutions when the quality of the generated child solutions is poor.

In operation 525, the processor 200 may determine whether the solutions of the replaced intermediate solution set satisfy termination criteria. In operation 527, the processor 200 may return a solution that satisfies the condition of operation 525 as an optimal result. The optimal result may include a target circuit structure.

The processor 200 may set a predetermined time as the termination criteria and search for an optimal solution for the predetermined time. The processor 200 may set a target value to be reached by the optimal solution as the termination criteria, and terminate the search for the optimal solution when the optimal solution reaches the target value.

When the condition of operation 525 is not satisfied, the processor 200 may iteratively perform operation 513.

FIG. 6 illustrates an example select operation, according to one or more embodiments.

Referring to FIG. 6, a processor (e.g., the processor 200 of FIG. 1) may select a portion of solutions from among a plurality of solutions included in an initial solution set. The processor 200 may select two solutions (e.g., corresponding to chromosomes of a genetic algorithm) from the solution set.

The processor 200 may prevent falling into a local minima by adjusting the selection process to select a solution with poor quality in order to secure diversity while increasing the probability of selecting a solution with good quality. The local minima may be a local optimization value that does not reach a global minimum within a predetermined range.

For example, the processor 200 may select a portion of solutions using roulette-wheel selection. The processor 200 may assign a higher probability value to a solution having higher quality and adjust a ratio of probability values using selection pressure as a parameter. Selection pressure may be a degree to which the selection probability is adjusted by adjusting a difference of fitness between excellent and inferior solutions.

FIG. 7 illustrates an example crossover operation, according to one or more embodiments.

Referring to FIG. 7, a processor (e.g., the processor 200 of FIG. 1) may generate a crossover solution by performing a crossover operation on a portion of solutions.

The processor 200 may generate a new solution (e.g., a crossover solution) using two solutions. The processor 200 may generate a crossover solution using partially matched crossover (PMX) or order crossover in a permutation problem.

The processor 200 may cut between nodes of two parent solutions. The position to be cut may be referred to as a cut point. In the example of FIG. 7, the cut points of S₁ may be between 0 and 6 and between 3 and 4. The cut points of S₂ may be between 3 and 1 and between 5 and 6.

The processor 200 may select a cut point based on a random value. The processor 200 may adjust the number of cut points.

The processor 200 may generate a child solution by copying a portion positioned between the cut points from S₁ and copying the remaining portion from S₂. Here, when there are values that are already used among the nodes of the child solution, the used values may be changed to other unused values.

The processor 200 may generate a crossover solution by modifying 3 before the cut point and 6 after the cut point to 5 and 1, respectively, in the child solution.

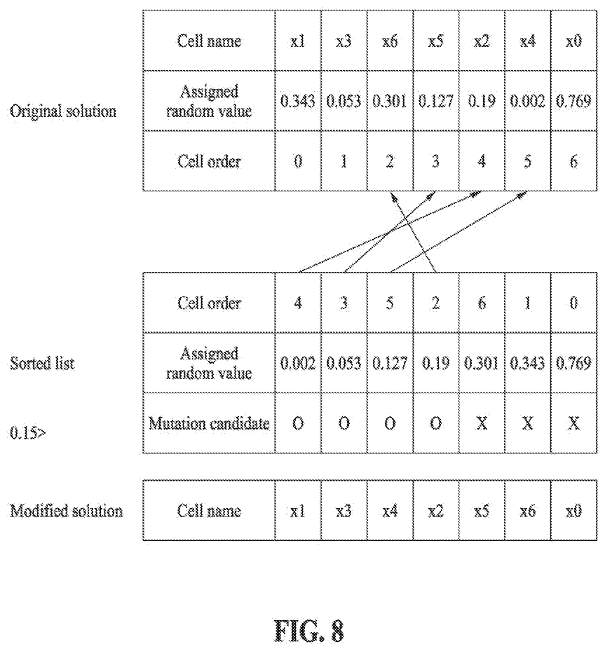

FIG. 8 illustrates an example mutation operation, according to one or more embodiments.

Referring to FIG. 8, a processor (e.g., the processor 200 of FIG. 1) may make a first change of the positions of nodes included in a crossover solution by performing a mutation operation on the crossover solution. The processor 200 may randomly set node values for the nodes included in the crossover solution.

The processor 200 may make the first change of the positions of the nodes by comparing the node values to a threshold. The processor 200 may make the first change of the positions of nodes having a node value less than or equal to the threshold. The threshold may be referred to as a mutation rate.

The processor 200 may randomly select a portion of the nodes (corresponding to genes in the genetic algorithm) and change the nodes to other values. The processor 200 may use uniform mutation of a 1D placement problem.

The processor 200 may assign a random value between 0 and 1 to each node. The processor 200 may make the first change of the positions of the nodes by swapping the nodes to which a node value less than or equal to the threshold is assigned. In the example of FIG. 8, the threshold may be 0.15.

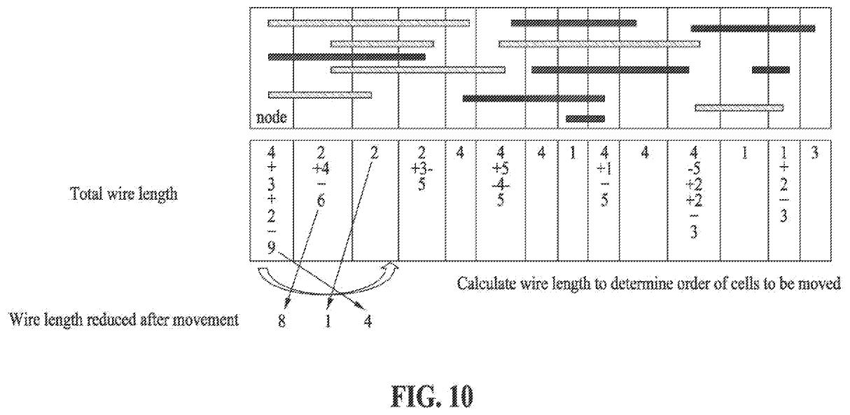

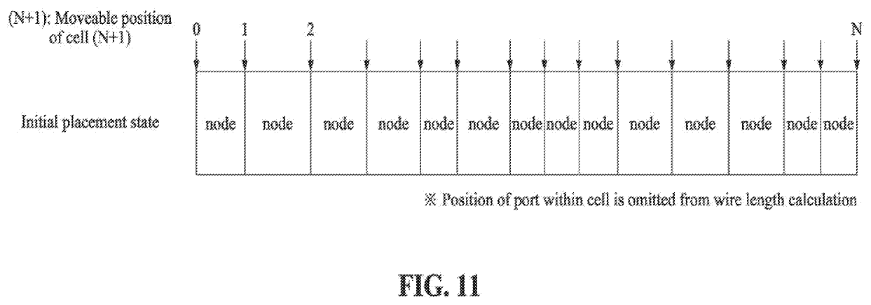

FIG. 9 illustrates an example operation of a local optimization (e.g., the local optimization of FIG. 5), according to one or more embodiments, FIG. 10 illustrates an example of a local optimization process (e.g., the local optimization process of FIG. 9), according to one or more embodiments, and FIG. 11 illustrates an example process of changing a position of a node, according to one or more embodiments.

Referring to FIGS. 9 to 11, a processor (e.g., the processor 200 of FIG. 1) may generate a target circuit structure by making a second change of the positions of the first changed nodes based on the lengths of edges connecting the nodes. The processor 200 may generate an intermediate solution set by performing local optimization by making the second change of the positions of the first changed nodes.

The processor 200 may perform a first calculation of a length of a wire corresponding to edges connected to each of the first changed nodes. The processor 200 may perform the first calculation of the length of the wire by adding a length of the wire connected to one side of the first changed nodes and a length of the wire connected to the other side of the first changed nodes.

The processor 200 may select a change node of which a position is to be changed from among the first changed nodes based on the first calculated wire length. The processor 200 may select a change node based on a length difference between the two wires connected to the first changed nodes.

The processor 200 may perform a second calculation of the length of the wire according to the position change of the change node.

The processor 200 may generate an intermediate solution set by making the second change of the positions of the first changed nodes based on the first calculated wire length and the second calculated wire length.

In operation 911, the processor 200 may receive an input solution. The input solution may include solutions generated as a result of a mutation. The input solution may represent one placement candidate.

In operation 913, the processor 200 may calculate a total wire length connected to the nodes included in the input solutions, and substitute 0 for i. Based on the wire length, the processor 200 may determine which node to move from all nodes to search for an optimal placement. The processor 200 may calculate a value (or a total wire length or weight) obtained by adding all the lengths of the wires connected to one node, and may list the nodes in order from a node with the longest wire length to a node with the shortest wire length.

In operation 915, the processor 200 may select a node (or cell) having an i-th lower weight. The processor 200 may search for the optimal placement by selecting the top n nodes as a result of the listing. When only one node is moved, the length of the wire connected to each node calculated previously may change. When a plurality of nodes are moved, the initially calculated total wire length becomes invalid and may fall into local optima. Accordingly, the processor 200 may search for the optimal placement using only n nodes instead of searching for the optimal placement by selecting all nodes.

In operation 917, the processor 200 may determine whether i is less than n. When the condition of operation 917 is satisfied, the processor 200 may calculate a total wire length at each position of the nodes and store the calculation result in operation 919. When the condition of operation 917 is not satisfied, the processor 200 may terminate the local optimization.

As shown in the examples of FIGS. 10 and 11, the processor 200 may calculate the total wire length by moving a node having the largest sum of connected wire lengths to a movable position based on the nodes selected in operation 915.

The processor 200 may make a second change of the positions of the nodes to positions where the wire length may be minimized based on the calculation result of the wire length. When the wire length is not minimized even after the nodes are moved, the processor 200 may stop and restart the local optimization from the beginning.

In operation 921, the processor 200 may determine whether the second changed nodes are optimal results. When the condition of operation 921 is satisfied, in operation 923, the processor 200 may change the position of the nodes to an optimal position. In operation 925, the processor 200 may increase i by 1. When the condition of operation 921 is not satisfied, the processor 200 may terminate the local optimization.

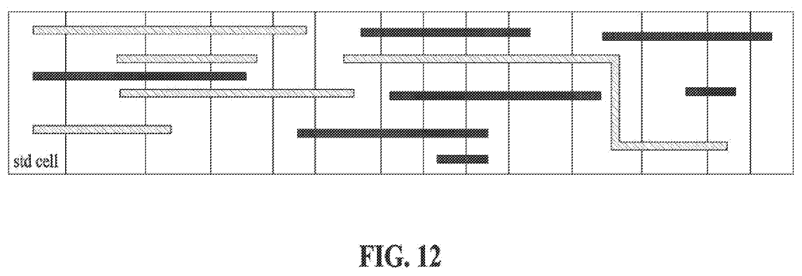

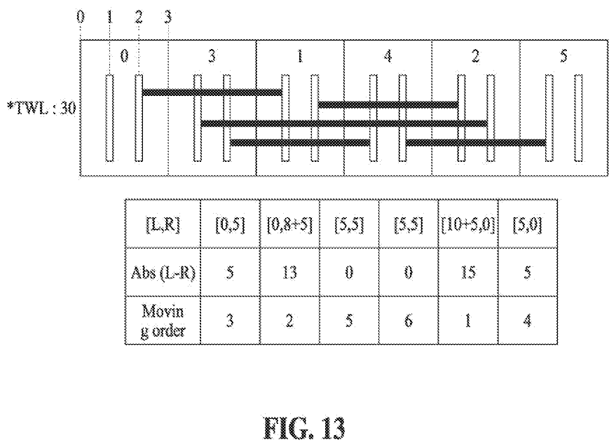

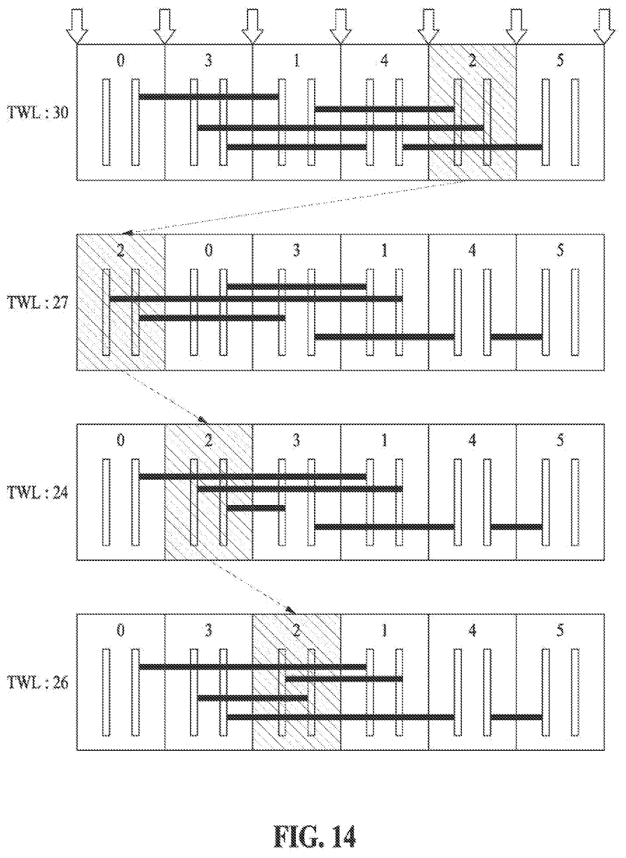

FIG. 12 illustrates an example process for minimizing a length of a wire, according to one or more embodiments, FIG. 13 illustrates an example process of changing a position of a node along a total wire length, according to one or more embodiments, and FIG. 14 illustrates an example of a change in wire length according to a movement of a position of a node, according to one or more embodiments.

Referring to FIGS. 12 to 14, a processor (e.g., the processor 200 of FIG. 1) may assign a point to each node (e.g., std cell) of a solution generated as a result of a mutation and exchange a worst case node with another node.

The processor 200 may express the sum of the lengths of wires connected to a node as a score of the node. The processor 200 may determine a final exchange position by searching for improvement (e.g., whether the wire length decreases) when the worst case node is moved to a position of another node.

When wires exist in both directions of a node, the processor 200 may mark one wire as minus and the other wire as plus. The processor 200 may mark only an absolute value of the length of the wire.

The processor 200 may perform the exchange when there is an advantage in exchanging the nodes connected to the edge (e.g., when the wire length decreases).

The processor 200 may perform local optimization using a greedy-K algorithm. In the examples of FIGS. 13 and 14, TWL may represent a total wire length. The processor 200 may sort candidate solutions based on the total wire length and determine the number of nodes to be sorted again. For example, the processor 200 may sort 40% of the number of nodes again.

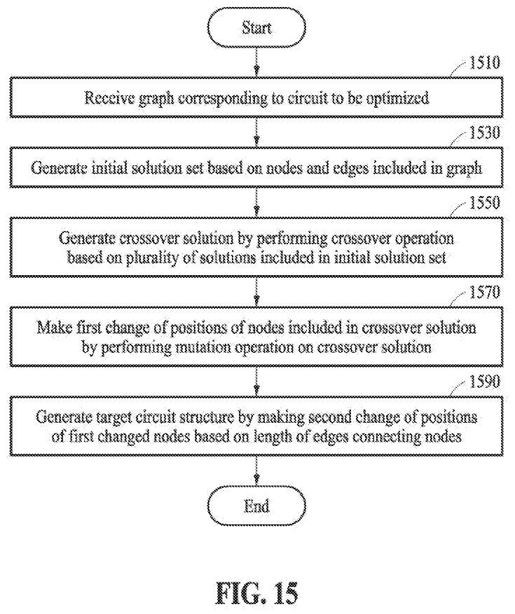

FIG. 15 illustrates an example operation of an apparatus (e.g., the apparatus illustrated in FIG. 1), according to one or more embodiments.

Referring to FIG. 15, in operation 1510, a receiver (e.g., the receiver 100 of FIG. 1) may receive a graph corresponding to a circuit to be optimized.

In operation 1530, a processor (e.g., the processor 200 of FIG. 1) may generate an initial solution set based on nodes and edges included in the graph. The processor 200 may generate a crossover solution by performing a crossover operation based on a plurality of solutions included in the initial solution set.

The processor 200 may select a portion of solutions from among the plurality of solutions included in the initial solution set. In operation 1550, the processor 200 may generate a crossover solution by performing a crossover operation on the portion of solutions.

In operation 1570, the processor 200 may make a first change of the positions of nodes included in the crossover solution by performing a mutation operation on the crossover solution. The processor 200 may randomly set node values for the nodes included in the crossover solution.

The processor 200 may make the first change of the positions of the nodes by comparing the node values to a threshold. The processor 200 may make the first change of the positions of nodes having a node value less than or equal to the threshold.

In operation 1590, the processor 200 may generate a target circuit structure by making a second change of the positions of the first changed nodes based on the lengths of the edges connecting the nodes. The processor 200 may generate an intermediate solution set by performing local optimization by making a second change of the positions of the first changed nodes.

The processor 200 may perform a first calculation of a length of a wire corresponding to edges connected to each of the first changed nodes. The processor 200 may perform the first calculation of the length of the wire by adding a length of the wire connected to one side of the first changed nodes and a length of the wire connected to the other side of the first changed nodes.

The processor 200 may select a change node of which a position is to be changed from among the first changed nodes based on the first calculated wire length. The processor 200 may select a change node based on a length difference between the two wires connected to the first changed nodes.

The processor 200 may perform a second calculation of the length of the wire according to the position change of the change node.

The processor 200 may generate an intermediate solution set by making the second change of the positions of the first changed nodes based on the first calculated wire length and the second calculated wire length.

The processor 200 may generate a target circuit structure by replacing a portion of solutions of the initial solution set with the intermediate solution set. The processor 200 may determine whether the solutions of the replaced intermediate solution set satisfy termination criteria. The processor 200 may determine a solution that satisfies the termination criteria as the target circuit structure.

The apparatuses, receivers, processors, memories, apparatus 10, receiver 100, processor 200, memory 300, and other apparatuses, devices, units, modules, and components disclosed and described herein with respect to FIGS. 1-15 are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-15 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. An apparatus with circuit designing, comprising:
one or more processors configured to:
generate an initial solution set based on nodes and edges comprised in a graph corresponding to a circuit to be optimized;
generate a crossover solution by performing a crossover operation based on a plurality of solutions comprised in the initial solution set;
perform a first change of positions of nodes comprised in the crossover solution by performing a mutation operation on the crossover solution; and
generate a target circuit structure by performing a second change of the positions of the first changed nodes based on lengths of the edges connecting the nodes.

2. The apparatus of claim 1, wherein the nodes comprised in the graph correspond to elements comprising the circuit, and the edges comprised in the graph correspond to wires connecting the elements.

3. The apparatus of claim 1, wherein, for the generating of the crossover solution, the one or more processors are configured to:
select a portion of solutions from among the plurality of solutions comprised in the initial solution set; and
generate the crossover solution by performing a crossover operation on the portion of solutions.

4. The apparatus of claim 1, wherein, for the performing of the first change, the one or more processors are configured to:
randomly set node values for the nodes comprised in the crossover solution; and
perform the first change of the positions of the nodes by comparing the node values to a threshold.

5. The apparatus of claim 4, wherein, for the performing of the first change of the positions of the nodes by comparing the node values to the threshold, the one or more processors are configured to perform the first change of the positions of nodes of which the node value is less than or equal to the threshold.

6. The apparatus of claim 1, wherein, for the generating of the target circuit structure, the one or more processors are configured to:
generate an intermediate solution set by performing local optimization by performing the second change of the positions of the first changed nodes; and
generate the target circuit structure by replacing the portion of solutions of the initial solution set with the intermediate solution set.

7. The apparatus of claim 6, wherein, for the generating of the intermediate solution set, the one or more processors are configured to:
determine a first wire length of a wire corresponding to edges connected to each of the first changed nodes;
select a change node of which a position is to be changed from among the first changed nodes based on the determined first wire length;
determine a second wire length of a wire according to the position change of the change node; and
generate the intermediate solution set by performing the second change of the positions of the first changed nodes based on the determined first wire length and the determined second wire length.

8. The apparatus of claim 7, wherein, for the determining of the first wire length, the one or more processors are configured to determine the first wire length by adding a length of the wire connected to one side of the first changed nodes and a length of the wire connected to the other side of the first changed nodes.

9. The apparatus of claim 7, wherein, for the selecting of the change node, the one or more processors are configured to select the change node based on a length difference between the two wires connected to the first changed nodes.

10. The apparatus of claim 6, wherein, for the generating of the target circuit structure by replacing the intermediate solution set, the one or more processors are configured to:
determine whether the solutions of the replaced intermediate solution set satisfy termination criteria; and
determine a solution that satisfies the termination criteria as the target circuit structure.

11. A processor-implemented method with circuit designing, comprising:
generating an initial solution set based on nodes and edges comprised in a graph corresponding to a circuit to be optimized;
generating a crossover solution by performing a crossover operation based on a plurality of solutions comprised in the initial solution set;
performing a first change of positions of nodes comprised in the crossover solution by performing a mutation operation on the crossover solution; and
generating a target circuit structure by performing a second change of the positions of the first changed nodes based on lengths of the edges connecting the nodes.

12. The method of claim 11, wherein the nodes comprised in the graph correspond to elements comprising the circuit, and the edges comprised in the graph correspond to wires connecting the elements.

13. The method of claim 11, wherein the generating of the crossover solution comprises:
selecting a portion of solutions from among the plurality of solutions comprised in the initial solution set; and
generating the crossover solution by performing a crossover operation on the portion of solutions.

14. The method of claim 11, wherein the performing of the first change comprises:
randomly setting node values for the nodes comprised in the crossover solution; and
performing the first change of the positions of the nodes by comparing the node values to a threshold.

15. The method of claim 14, wherein the performing of the first change of the positions of the nodes by comparing the node values to the threshold comprises performing the first change of the positions of nodes of which the node value is less than or equal to the threshold.

16. The method of claim 11, wherein the generating of the target circuit structure comprises:
generating an intermediate solution set by performing local optimization by performing the second change of the positions of the first changed nodes; and
generating the target circuit structure by replacing the portion of solutions of the initial solution set with the intermediate solution set.

17. The method of claim 16, wherein the generating of the intermediate solution set comprises:
determining a first wire length of a wire corresponding to edges connected to each of the first changed nodes;
selecting a change node of which a position is to be changed from among the first changed nodes based on the determined first wire length;
determining a second wire length of a wire according to the position change of the change node; and
generating the intermediate solution set by performing the second change of the positions of the first changed nodes based on the determined first wire length and the determined second wire length.

18. The method of claim 17, wherein the determining of the first wire length comprises determining the first wire length by adding a length of the wire connected to one side of the first changed nodes and a length of the wire connected to the other side of the first changed nodes.

19. The method of claim 17, wherein the selecting of the change node comprises selecting the change node based on a length difference between the two wires connected to the first changed nodes.

20. The method of claim 16, wherein the generating of the target circuit structure by replacing the intermediate solution set comprises:
determining whether the solutions of the replaced intermediate solution set satisfy termination criteria; and
determining a solution that satisfies the termination criteria as the target circuit structure.
